(19) United States
(12) Patent Application Publication
(10) Pub. No.: US 2026/0234750 A1
(43) Pub. Date: Aug. 13, 2026

(54) FLASH SMELTING FURNACE, FLASH SMELTING FURNACE OPERATION METHOD, AND METAL SMELTING METHOD

(71) Applicant: JX Advanced Metals Corporation, Tokyo (JP)

(72) Inventors: Tatsuya MOTOMURA, Tokyo (JP); Tsuyoshi KANAMORI, Oita-shi Oita (JP)

(73) Assignee: JX Advanced Metals Corporation, Tokyo (JP)

(21) Appl. No.: 19/640,199

(22) Filed: Apr. 6, 2026

Related U.S. Application Data
(63) Continuation of application No. PCT/JP2025/022117, filed on Jun. 19, 2025.

(30) Foreign Application Priority Data
Sep. 24, 2024 (JP) 2024-164935

(51) Int. Cl. C22B 15/00; F27B 1/21; F27B 1/26; F27D 3/15

(52) U.S. Cl. CPC C22B 15/0047; F27B 1/21; F27B 1/26; F27D 3/1518; F27M 2003/13

(57) ABSTRACT

To reduce risks associated with an increase of the charging proportion of a metal-based recycled raw material.

A flash smelting furnace that separates a high temperature molten material produced by causing a raw material to react with oxygen in a reaction shaft 2 into a matte layer 3a containing matte which is a sulfide of a predetermined metal and a slag layer 3b present on the matte layer on a furnace bottom surface of a settler 3 includes: a predetermined slope area S2 provided on the furnace bottom surface S in order to guide molten metal which is a molten material of the predetermined metal having remaining at a lower part of the matte layer without being sulfided to a side of a furnace wall 3W of the settler; and metal tap holes Hc and Hc formed through the furnace wall in order to withdraw, to an outside of the furnace, the molten metal accumulated at a bottom part of the slope area.

### TECHNICAL FIELD

The present invention relates to a flash smelting furnace, a flash smelting furnace operation method, and a metal smelting method used for metal smelting of copper or the like.

### BACKGROUND ART

For example, as illustrated in FIG. 7 of Patent Literature 1, a flash smelting furnace used for metal smelting of copper or the like includes a reaction shaft (2), a settler (3), and an uptake shaft (4), and a concentrate burner (7) is provided at the top part of the reaction shaft (2). The raw material including concentrate is blown into the inside of the furnace by the concentrate burner (7) together with oxygen-enriched air or high temperature hot air to undergo a chemical reaction momentarily and is separated, on the furnace bottom surface of the settler (3), into a matte layer (6) containing matte which is a copper sulfide and a slag layer (5) on the matte layer (6) (note that numerals in the parentheses are reference signs in Patent Literature 1; the same applies hereinbelow).

The matte in the matte layer (6) is withdrawn through matte tap holes provided through a furnace wall disposed along the long-side direction of the settler (3), and a slag in the slag layer (5) is withdrawn through slag tap holes provided through a furnace wall disposed on the side of the uptake shaft (4) along the short-side direction of the settler (3). The slag withdrawn through the slag tap holes is treated in an SC furnace, and copper having been mixed in the slag is recovered. The recovered copper is processed in a converter together with the matte withdrawn through the matte tap holes. The processed copper is electrolytically refined into higher-grade electrolytic copper.

### CITATION LIST

### Patent Literatures

Patent Literature 1: JP-2011-075183A
Patent Literature 2: JP-2012-057905A
Patent Literature 3: JP-2017-155260A
Patent Literature 4: JP-2017-155260A

### SUMMARY OF INVENTION

### Technical Problem

Since the proportion of a copper-metal-based recycled raw material in a raw material has been increasing in recent years, the ratio of copper metal left unsulfided inside a furnace tends to increase. In a case where the copper metal is accumulated on the furnace bottom surface having a round bottom shape of a flash smelting furnace and left remaining for a long term, impurities contained in the copper metal are condensed, resulting in a low-melting point state. There is a possibility that the copper metal penetrates into the joints of furnace bottom bricks or infiltrate into the furnace bottom bricks themselves, and accordingly the risks of loss of the thermal insulation function of the furnace bottom bricks and occurrence of molten material leakage from the furnace bottom increase. In addition, in a case where the surface level of the remaining copper metal reaches a matte tap hole level, and the copper metal is mixed in matte withdrawn through the matte tap holes, for example, the risk that a matte gutter made of copper is damaged increases; in addition, the risk that high impurity metal is unintentionally and undesirably supplied to a converter and the risk that water-cooling elements made of copper included in the furnace wall of the flash smelting furnace is damaged also increase. To reduce these risks, conventional flash smelting furnaces allow a copper-metal-based recycled raw material to be charged only within such an extent that copper metal is not generated or such an extent that its generation amount is negligible, presenting a problem that the processing efficiency of the recycled raw material cannot be increased to a certain level or higher.

In view of the problems described above, an object of the present invention is to provide a flash smelting furnace, a flash smelting furnace operation method, and a metal smelting method configured to be capable of reducing risks associated with an increase of the charging proportion of a metal-based recycled raw material.

### Solution to Problem

One of flash smelting furnaces according to the present invention is a flash smelting furnace that separates a high temperature molten material produced by causing a raw material to react with oxygen in a reaction shaft into a matte layer containing matte which is a sulfide of a predetermined metal and a slag layer present on the matte layer on a furnace bottom surface of a settler, the flash smelting furnace including: a predetermined slope area provided on the furnace bottom surface in order to guide molten metal which is a molten material of the predetermined metal having remaining at a lower part of the matte layer without being sulfided to a side of a furnace wall of the settler; and a metal tap hole formed through the furnace wall in order to withdraw, to an outside of the furnace, the molten metal accumulated at a bottom part of the slope area.

In any one of flash smelting furnaces according to the present invention, a formation range of the slope area may be a predetermined range below the reaction shaft.

In any one of flash smelting furnaces according to the present invention, the furnace bottom surface of the settler may be an upper end surface of a brick array incorporated into a round bottom shape, with a reverse arched shape in cross-section, and a cross-sectional shape of the slope area of the furnace bottom surface may be a reverse arched shape tilted such that a vertical position of a skew brick part on a side of the metal tap hole is lower than a vertical position of a skew brick part on a side opposite to the metal tap hole.

In any one of flash smelting furnaces according to the present invention, a cross-sectional shape of a non-slope area of the furnace bottom surface may have a reverse arched shape in which a vertical position of one skew brick part is the same as a vertical position of the other skew brick part.

In any one of flash smelting furnaces according to the present invention, a vertical position of a bottom part of the slope area of the furnace bottom surface may be lower than a vertical position of a bottom part of a non-slope area of the furnace bottom surface.

In any one of flash smelting furnaces according to the present invention, a vertical position of a matte tap hole of the furnace wall may be set to the vertical position of the skew brick part of the non-slope area, and a vertical position of the metal tap hole of the furnace wall may be set to the vertical position of the skew brick part on the side of the metal tap hole of the slope area.

In any one of flash smelting furnaces according to the present invention, a horizontal position of the metal tap hole of the furnace wall may be adjusted not to be the same as a horizontal position of the matte tap hole of the furnace wall.

Any one of flash smelting furnaces according to the present invention may further include a gas-cooling mechanism that cools a furnace bottom of the settler for each of areas of the furnace bottom.

Any one of flash smelting furnaces according to the present invention may further include a heat removal amount measurement unit that measures an amount of heat removal by the gas-cooling mechanism for each of areas of the furnace bottom.

Any one of flash smelting furnaces according to the present invention may further include a thermometer unit that measures temperature of the furnace bottom of the settler for each of areas of the furnace bottom.

One of flash smelting furnace operation methods according to the present invention is an operation method of any one of flash smelting furnaces according to the present invention, the operation method including starting a process of withdrawing the molten metal through the metal tap hole of the furnace wall in a case where a surface level of the molten metal has reached a matte tap hole level or in a case where the surface level of the molten metal is predicted to have reached the matte tap hole level.

Any one of flash smelting furnace operation methods according to the present invention may further include determining whether or not the surface level of the molten metal has reached the matte tap hole level on a basis of whether or not the molten metal has started being mixed in the matte withdrawn through the matte tap hole of the furnace wall.

Any one of flash smelting furnace operation methods according to the present invention may further include determining whether or not the surface level of the molten metal has reached the matte tap hole level on a basis of whether or not an adhesion range of the molten metal on an inspection level gauging rod inserted through an inspection level gauging hole of the settler has reached a level corresponding to the matte tap hole level.

Any one of flash smelting furnace operation methods according to the present invention may further include stopping the process of withdrawing the molten metal through the metal tap hole in a case where the surface level of the molten metal has lowered to a second level lower than the matte tap hole level or in a case where the surface level of the molten metal is predicted to have reached the second level.

Any one of flash smelting furnace operation methods according to the present invention may further include determining whether or not the surface level of the molten metal has lowered to the second level on a basis of whether or not an adhesion range of the molten metal on an inspection level gauging rod inserted through an inspection level gauging hole of the settler has lowered to a level corresponding to the second level.

Any one of flash smelting furnace operation methods according to the present invention may further include: stopping the process of withdrawing the matte through a matte tap hole of the furnace wall in a case where the process of withdrawing the molten metal through the metal tap hole is started; and stopping the process of withdrawing the molten metal through the metal tap hole in a case where the process of withdrawing the matte through the matte tap hole of the furnace wall is started.

Any one of flash smelting furnace operation methods according to the present invention may further include performing a process of withdrawing all molten material including the molten metal, the matte, and the slag through the metal tap hole as necessary.

Any one of flash smelting furnace operation methods according to the present invention may further include increasing a flow rate of a cooling gas for an area where thermal load estimated from the heat removal amount or the temperature exceeds a predetermined range in a case where there is such an area.

Any one of flash smelting furnace operation methods according to the present invention may further include reducing a flow rate of a cooling gas for an area where thermal load estimated from the heat removal amount or the temperature falls below the predetermined range in a case where there is such an area.

One of metal smelting methods according to the present invention is a metal smelting method using any one of flash smelting furnaces according to the present invention, the metal smelting method including supplying molten metal withdrawn through the metal tap hole of the flash smelting furnace to a first post-process furnace together with flash smelting furnace matte withdrawn through the matte tap hole of the flash smelting furnace.

Any one of metal smelting methods according to the present invention may further include: separating a flash smelting furnace slag withdrawn through a slag tap hole of the flash smelting furnace into second matte containing the metal and a second slag present on the second matte by supplying the flash smelting furnace slag to a second post-process furnace; and supplying the second matte to the first post-process furnace.

Any one of metal smelting methods according to the present invention may further include, when the second post-process furnace is being operated, executing at least one of: a process of reducing the second slag; a process of increasing temperature of the second slag; a process of supplying an additive for modifying the second slag; a process of oxidizing the second slag; a process of oxidizing the second matte; a process of increasing temperature of the second matte; or a process of oxidizing the molten metal.

Any one of metal smelting methods according to the present invention may further include allowing molten metal to be mixed into the flash smelting furnace matte and supplying the flash smelting furnace matte in which the molten metal is mixed to the first post-process furnace.

Any one of metal smelting methods according to the present invention may further include: allowing molten metal to be mixed into the flash smelting furnace slag and supplying the flash smelting furnace slag in which the molten metal is mixed to the second post-process furnace; and causing the molten metal to settle on a furnace bottom surface of the second post-process furnace and supplying the molten metal having settled to the first post-process furnace together with the second matte.

In any one of metal smelting methods according to the present invention, the raw material may include a recycled raw material, and the metal smelting method may further include adjusting weight ratios of a smaller particulate raw material and a particulate raw material in the recycled raw material in order to adjust balance between an amount of molten metal withdrawn from the second post-process furnace and an amount of molten metal withdrawn from the flash smelting furnace.

Any one of metal smelting methods according to the present invention may further include adjusting a pretreatment condition of the recycled raw material in order to adjust the weight ratios.

### Advantageous Effects of Invention

Since the flash smelting furnace according to the present invention includes: the slope area that guides molten metal remaining at a lower part of the matte layer without being sulfided to the side of the furnace wall of the settler; and the metal tap hole through which the molten metal accumulated at the bottom part of the slope area is withdrawn to the outside of the furnace, the molten metal can be withdrawn timely and smoothly. Therefore, it is possible to reduce or avoid: (1) the risk that molten metal accumulated at the middle of the furnace bottom surface of the flash smelting furnace leaks from the furnace bottom; (2) the risk that molten metal that has reached the matte tap hole level damages a matte gutter made of copper; (3) the risk that high impurity metal is unintentionally and undesirably supplied to a converter; and (4) the risk that water-cooling elements made of copper included in the furnace wall of the flash smelting furnace is damaged. Accordingly, the flash smelting furnace and the operation method thereof according to the present invention achieve the advantageous effect that risks associated with an increase of the charging proportion of a metal-based recycled raw material can be reduced.

Since the metal smelting method of the flash smelting furnace according to the present invention uses the flash smelting furnace according to the present invention, the metal smelting method achieves the advantageous effect that a recycled raw material can be processed safely.

### BRIEF DESCRIPTION OF DRAWINGS

FIG. 1 is a schematic front cross-sectional view of a flash smelting furnace according to an embodiment.

FIG. 2 is a schematic perspective view of the shape of the furnace bottom surface of a settler.

FIG. 3 is a schematic cross-sectional view of the inside of the front furnace wall of the settler.

FIG. 4 is a cross-sectional view taken along X-X in FIG. 1.

FIG. 5 is a cross-sectional view taken along Y-Y in FIG. 1.

FIG. 6 is an explanatory diagram for explaining the configuration of an air-cooling mechanism disposed below the furnace bottom.

FIG. 7 is an explanatory diagram for explaining the layout of a thermometer unit in the cross-section taken along X-X in FIG. 1.

FIG. 8 is an explanatory diagram for explaining the layout of the thermometer unit in the cross-section taken along Y-Y in FIG. 1.

FIG. 9 is a schematic diagram for explaining the procedure of a conventional copper smelting method.

FIG. 10 is a schematic diagram for explaining the procedure of an embodiment of a copper smelting method.

FIG. 11 is a schematic diagram for explaining the procedure of a second embodiment of the copper smelting method.

### DESCRIPTION OF EMBODIMENTS

### 1. Embodiments

Hereinbelow, embodiments of a flash smelting furnace and an operation method thereof according to the present invention are explained.

Whereas it is assumed here that in particular copper is a predetermined metal, and a flash smelting furnace and an operation method thereof to be used for copper smelting are explained as examples, the present invention can be applied also to a flash smelting furnace and an operation method thereof to be used for smelting a metal other than copper.

### 1-1. Configuration of Flash Smelting Furnace

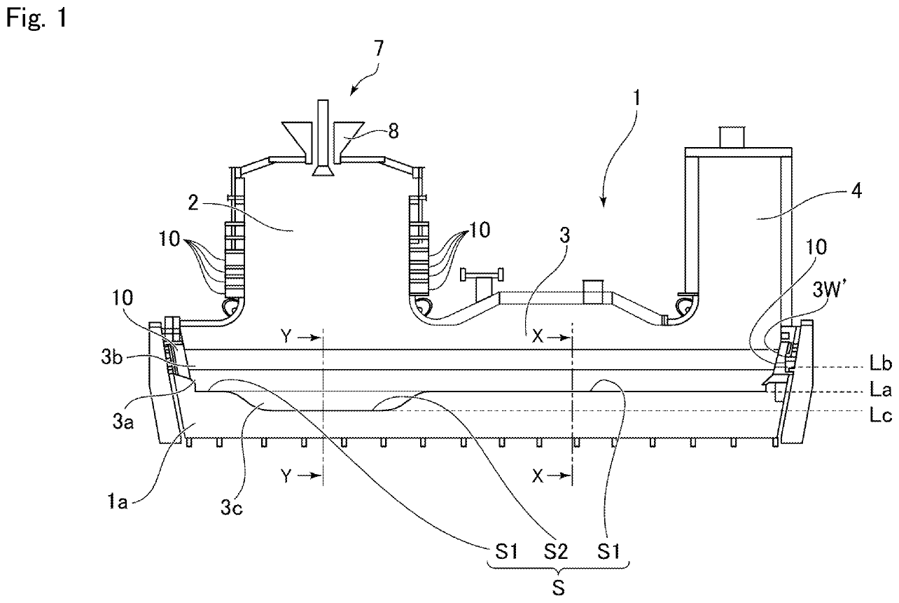

Hereinbelow, the configuration of the flash smelting furnace is explained. FIG. 1 is a schematic front cross-sectional view of the flash smelting furnace according to the present embodiment. Note that the irregular shape of a furnace bottom surface S is exaggerated in FIG. 1 than it actually is.

As illustrated in FIG. 1, a flash smelting furnace 1 according to the present embodiment includes: a settler 3 having an approximately rectangular shape in plan view; a reaction shaft 2 having an approximately cylindrical shape protruding from a ceiling part of the settler 3 closer to an end thereof; and an uptake shaft 4 protruding from a ceiling part of the settler 3 closer to the other end thereof. The whole of the furnace body of the flash smelting furnace 1 includes a shell (cylindrical body) including a metallic material such as a steel material. A concentrate burner 7 is disposed at the upper part of the reaction shaft 2, and an oxygen-enriched air supplying part 8 is provided at the concentrate burner 7. When the raw material is blown into the inside of the reaction shaft 2 via the supplying part 8 simultaneously with oxygen-enriched air or high temperature hot air, a chemical reaction is induced momentarily. Due to specific gravity differences, the reacted raw material is separated into a matte layer 3a containing matte which is a copper sulfide and a slag layer 3b present on the matte layer 3a on a surface (hereinbelow, referred to as the “furnace bottom surface S”) of a furnace bottom 1a of the settler 3. For example, the copper grade (weight %) of the matte layer 3a is 65%, and the slag layer 3b contains iron oxide, silica, and the like. Then, an exhaust gas at the upper part of the slag layer 3b is guided to a waste heat boiler (not illustrated) via the uptake shaft 4, and an exhaust gas cooled at the waste heat boiler is transferred to a sulfuric acid plant.

### 1-2. Shape of Furnace Bottom Surface

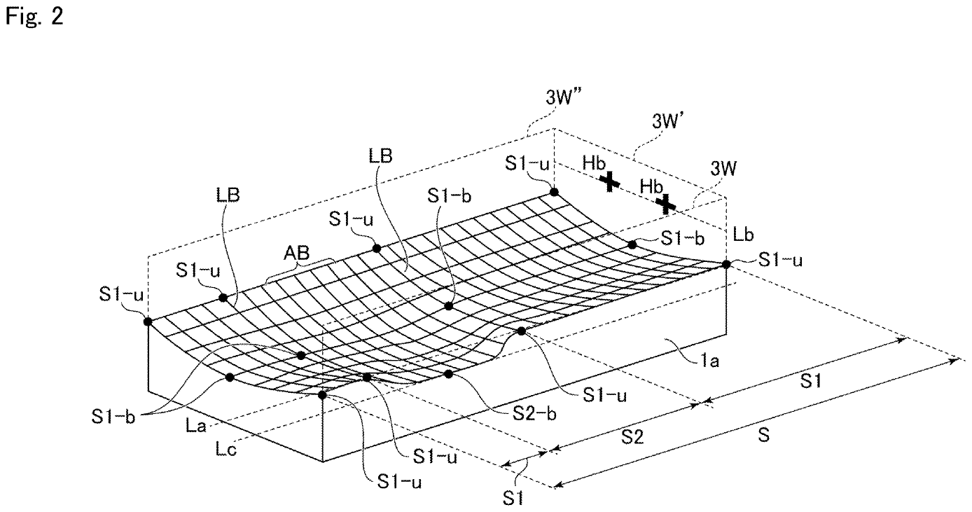

Hereinbelow, a summary of the shape of the furnace bottom surface S of the settler 3 is explained. FIG. 2 is a schematic perspective view of the shape of the furnace bottom surface of the settler. Note that grid lines in FIG. 2 are drawn to clarify the shape of the furnace bottom surface S and do not necessarily illustrate the boundaries between furnace bottom bricks. In addition, all of a front furnace wall 3W, a side furnace wall 3W′, and a back furnace wall 3W″ in FIG. 2 are drawn as vertical surfaces, but actually are inclined surfaces.

As illustrated in FIG. 2, the furnace bottom 1a of the settler 3 includes a furnace bottom brick array incorporated into a round bottom shape, with a reverse arched shape in cross-section, and the upper end surface of the furnace bottom brick array is used as the furnace bottom surface S. A predetermined range below the reaction shaft 2 in the furnace bottom surface S where matte particles and slag particles are suspended is a predetermined slope area S2. Here, the “predetermined range” is a range with a predetermined length that is formed by dividing the furnace bottom surface S in the long-side direction as illustrated in FIG. 2, and in particular means an area having a square (rectangle) shape in plan view covering the projection region of the reaction shaft 2. Alternatively, the “predetermined range” means a square (rectangle) area in plan view formed by expanding a square (rectangle) area in plan view covering the projection region of the reaction shaft 2 in the direction toward the side furnace wall 3W′. The slope area S2 in the predetermined range is provided with a smooth gradient. Therefore, molten metal which is a molten material of a predetermined metal (here, copper) which is supplied from the concentrate burner 7 and is settled/remaining at a lower part of the matte layer 3a (FIG. 1) without being sulfided is guided by the gradient of the slope area S2, and remains on the side of the front-side furnace wall 3W (hereinbelow, referred to as the “front furnace wall 3W”) disposed along the long-side direction of the settler 3. Note that the low-melting point state of molten metal that causes the aforementioned risks is caused by the condensation of impurities having transitioned from matte to molten metal over time. Note that there is a possibility that the “molten metal” in the present specification contains also impurities such as iron, tin, and lead in addition to an element (here, the copper element) of the predetermined metal.

A bottom part S2-b, which is the lowest portion of the slope area S2, is a portion contacting the front furnace wall 3W. The vertical position of the bottom part S2-b is lower than the vertical position of a bottom part S1-b of a non-slope area S1 and is equivalent to a metal tap hole level Lc. The metal tap hole level Lc is the vertical position of metal tap holes Hc mentioned later.

Top parts S1-u, which are the highest portions of the non-slope area S1 are portions of the non-slope area S1 contacting the front furnace wall 3W and portions contacting the furnace wall (hereinbelow, referred to as the “back furnace wall 3W″”) opposite to the front furnace wall 3W. The vertical position of the top parts S1-u is equivalent to a matte tap hole level La. The matte tap hole level La is the vertical position of matte tap holes Ha mentioned later.

Note that the slope area S2 and the non-slope area S1 are smoothly continuous at their boundary, and accordingly the furnace bottom surface S as a whole is a smooth curved surface.

### 1-3. Configuration of Tap Holes

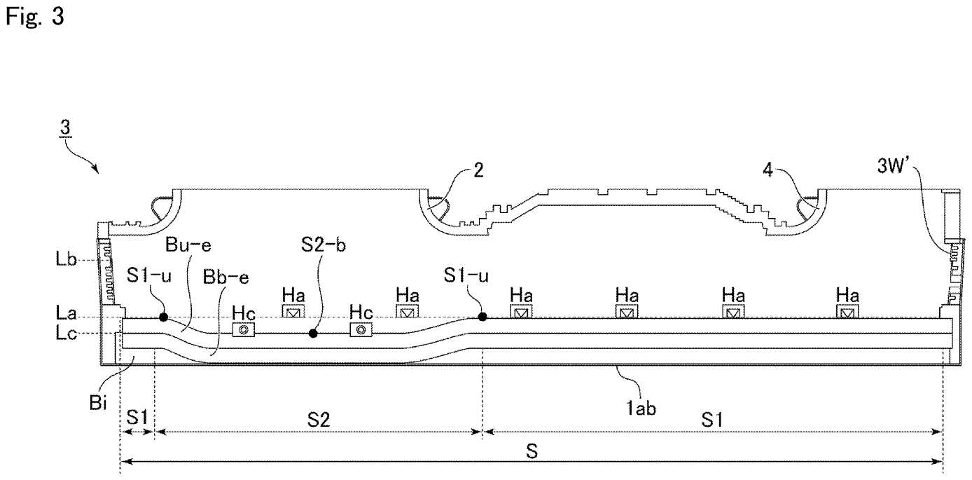

FIG. 3 is a schematic cross-sectional view of the inside of the front furnace wall of the settler. As illustrated in FIG. 3 and the abovementioned FIG. 2, the flash smelting furnace 1 of the present embodiment is provided with: a plurality of matte tap holes (here, six matte tap holes) Ha, Ha, Ha, Ha, Ha, and Ha for withdrawing matte in the matte layer 3a to the outside of the furnace; a plurality of slag tap holes (here, two slag tap holes) Hb and Hb for withdrawing a slag in the slag layer 3b to the outside of the furnace (see FIG. 2); and a plurality of metal tap holes (here, two metal tap holes) Hc and Hc for withdrawing molten metal remaining at a lower part of matte 3a without being sulfided inside the furnace to the outside of the furnace. For example, the structure of the metal tap holes Hc is similar to the structure of the matte tap holes Ha.

The six matte tap holes Ha, Ha, Ha, Ha, Ha, and Ha are formed through the front furnace wall 3W. In the front furnace walls 3W, the six matte tap holes Ha, Ha, Ha, Ha, Ha, and Ha are provided next to each other in the horizontal direction.

The two slag tap holes Hb and Hb are formed through a predetermined furnace wall 3W′ (hereinbelow, referred to as a “side furnace wall 3W′”) disposed near the uptake shaft 4 along the short-side direction of the settler 3. In the side furnace wall 3W′, the two slag tap holes Hb and Hb are provided next to each other in the horizontal direction.

The two metal tap holes Hc and Hc are formed through the front furnace wall 3W through which the six matte tap holes Ha, Ha, Ha, Ha, Ha, and Ha are formed. By forming the two metal tap holes Hc and Hc through the front furnace wall 3W through which the six matte tap holes Ha, Ha, Ha, Ha, Ha, and Ha are formed in this manner, access to the two types of tap hole, the metal tap holes Hc and the matte tap holes Ha, can be facilitated.

Here, the horizontal positions of the metal tap holes Hc are adjusted not to be the same as the horizontal positions of the matte tap holes Ha.

This is because, if the matte tap holes Ha are positioned directly above the metal tap holes Hc, constraints will arise in the layout of a metal gutter connected to the metal tap holes Hc and a matte gutter connected to the matte tap holes Ha.

In the abovementioned flash smelting furnace 1, molten material (slag) withdrawn through at least one of the two slag tap holes Hb and Hb is transferred to an unillustrated SC furnace, and matte contained in the molten material is recovered. After being processed in a converter together with molten material (matte) withdrawn through at least one of the six matte tap holes Ha, Ha, Ha, Ha, Ha, and Ha, the recovered matte is electrolytically refined into higher-grade electrolytic copper. On the other hand, molten material (molten metal) withdrawn through at least one of the two metal tap holes Hc and Hc is processed at any one of a slag production phase or a blister copper production phase of the converter depending on at least either of the copper grade or impurity concentration. Alternatively, the molten metal withdrawn through at least one of the metal tap holes Hc and Hc is processed outside the system.

### 1-4. Structure of Furnace Bottom

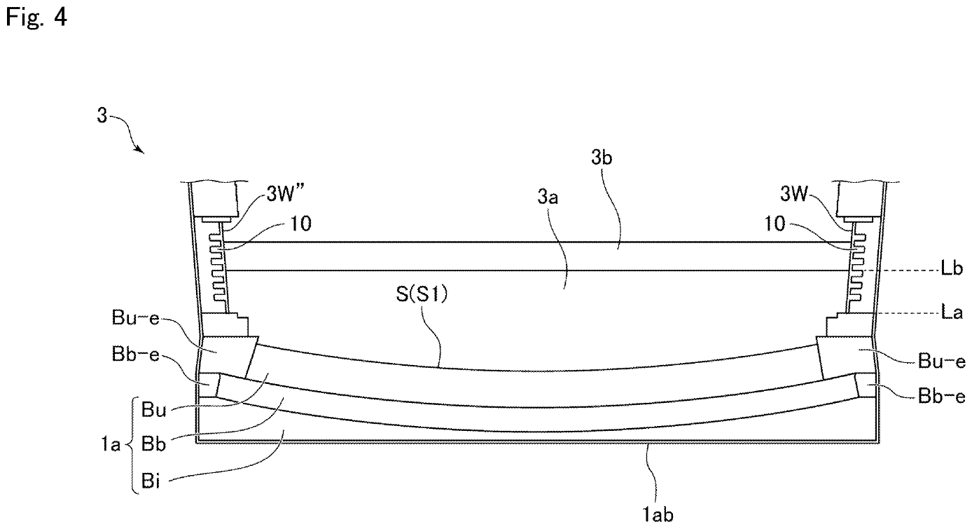

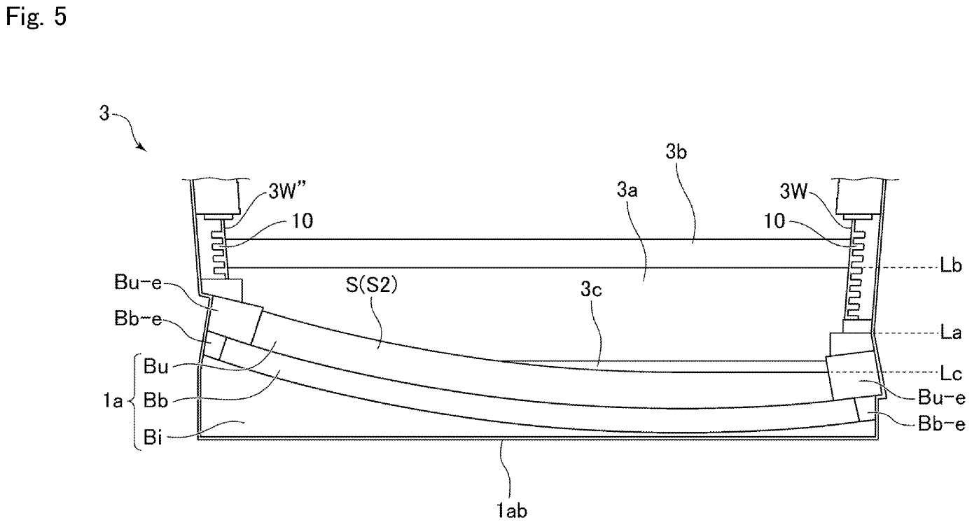

Hereinbelow, the structure of the furnace bottom 1a of the settler 3 is explained. FIG. 4 is a cross-sectional view taken along X-X in FIG. 1, and FIG. 5 is a cross-sectional view taken along Y-Y in FIG. 1. The X-X cross section is a cross-section taken near the middle of the non-slope area S1 on the side of the uptake shaft 4, and the Y-Y cross section is a cross-section crossing the bottom part S2-b of the slope area S2.

As illustrated in FIG. 4 and FIG. 5, both of the front furnace wall 3W and the back furnace wall 3W″ of the settler 3 include a plurality of water-cooling elements 10, 10, . . . coupled next to each other in the horizontal direction, a plate-like steel shell 1ab, a filling brick area Bi, a lower furnace bottom brick area Bb, and an upper furnace bottom brick area Bu are disposed sequentially from the lower-layer side on the furnace bottom 1a of the settler 3, and the upper end surface of the upper furnace bottom brick area Bu is used as the furnace bottom surface S. Both ends of the upper furnace bottom brick area Bu in the short-side direction are provided with skew brick parts Bu-e and Bu-e, and both ends of the lower furnace bottom brick area Bb in the short-side direction are provided with skew brick parts Bb-e and Bb-e.

A plurality of upper furnace bottom bricks with an arch rise structure are arrayed in the upper furnace bottom brick area Bu, a plurality of lower furnace bottom bricks with an arch rise structure are arrayed in the lower furnace bottom brick area Bb, the filling brick area Bi is filled with a plurality of furnace bottom filling bricks, a plurality of skew bricks or a single skew brick are/is disposed in each of the skew brick parts Bu-e, Bu-e, Bb-e, and Bb-e, and the gap between the lower furnace bottom brick area Bb and the filling brick area Bi is filled with a monolithic refractory material. Note that “skew bricks” mean bricks that support one end or the other end of an arch rise structure.

### 1-5. Details of Non-Slope Area

Hereinbelow, details of the non-slope area S1 are explained with reference to FIG. 4.

As illustrated in FIG. 4, since, below the non-slope area S1, the plurality of upper furnace bottom bricks included in the upper furnace bottom brick area Bu are assembled in the arch rise structure, and the plurality of lower furnace bottom bricks included in the lower furnace bottom brick area Bb also are assembled in the arch rise structure, the cross-sectional shape of the non-slope area S1 has a reverse arched shape.

In addition, below the non-slope area S1, the postures of the upper furnace bottom brick area Bu and the lower furnace bottom brick area Bb are symmetric with respect to a vertical plane including the centerline extending in the long-side direction of the settler 3, and the vertical position of the upper end of the skew brick part Bu-e of one end and the vertical position of the upper end of the skew brick part Bu-e of the other end are the same.

Note that, in FIG. 4, the vertical positions of the upper ends of the skew brick parts Bu-e are equivalent to the aforementioned matte tap hole level La.

### 1-6. Details of Slope Area

Hereinbelow, details of the slope area S2 are explained with reference to FIG. 5.

As illustrated in FIG. 5, since, below the slope area S2, the plurality of upper furnace bottom bricks included in the upper furnace bottom brick area Bu are assembled in the arch rise structure, and the plurality of lower furnace bottom bricks included in the lower furnace bottom brick area Bb also are assembled in the arch rise structure, the cross-sectional shape of the slope area S2 has a reverse arched shape.

It should be noted that, below the slope area S2, the postures of the upper furnace bottom brick area Bu and the lower furnace bottom brick area Bb are tilted, the vertical position of the upper end of the skew brick part Bu-e on the side of the metal tap holes Hc (on the side of the predetermined furnace wall 3W) is lower than the vertical position of the upper end of the skew brick part Bu-e on the side opposite to the metal tap holes Hc (on the side opposite to the predetermined furnace wall 3W).

Moreover, the degree of tilt (tilt amount) of the slope area S2 depends on the position in the long-side direction of the settler 3.

Specifically, as illustrated in FIG. 2, in the slope area S2, the tilt amount is set to zero along the boundary lines LB with the non-slope area S1. In a strip area AB including the bottom part S2-b, the tilt amount is set to the maximum value, and the tilt amount gradually increases from the boundary lines LB toward the strip area AB.

Note that, in order to ensure an appropriate tilt amount, the thickness of the upper furnace bottom brick area Bu and/or the lower furnace bottom brick area Bb may be reduced in an area equivalent to an area below the slope area S2 in the furnace bottom 1a (in particular, an area below the strip area AB) if necessary.

In addition, in the area equivalent to the area below the slope area S2 in the furnace bottom 1a, the shapes of the skew brick parts Bu-e and Bb-e at both ends of the upper furnace bottom brick area Bu and the lower furnace bottom brick area Bb and the shapes of side walls for constraining the skew brick parts Bu-e and Bb-e are set to appropriate shapes according to the tilt amount.

Note that, in FIG. 5, the vertical position of the upper end of the skew brick part Bu-e on the side of the metal tap holes Hc (the side of the front furnace wall 3W) is equivalent to the metal tap hole level Lc. The metal tap hole level Lc is a level lower than the matte tap hole level La by approximately 400 mm to 600 mm.

### 1-7. Configuration of Air-Cooling Mechanism

Hereinbelow, an air-cooling mechanism is explained.

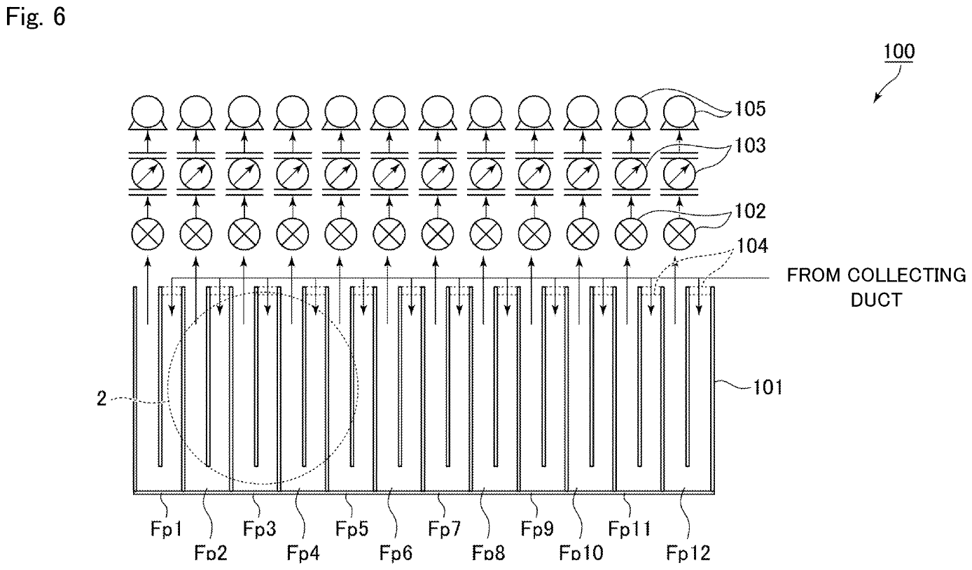

FIG. 6 is an explanatory diagram for explaining the configuration of the air-cooling mechanism disposed below the furnace bottom. Whereas it is assumed here that air (air) is the cooling gas, the type of the gas is not limited to air.

As illustrated in FIG. 6, the flash smelting furnace 1 of the present embodiment is provided with an air-cooling mechanism 100 as a gas-cooling mechanism that cools the furnace bottom 1a of the settler 3. The air-cooling mechanism 100 cools the furnace bottom 1a for each of 12 divided areas obtained by dividing the furnace bottom 1a in the long-side direction.

The air-cooling mechanism 100 includes a metallic buried tube 101 such as iron laid immediately under the steel shell 1ab of the furnace bottom 1a.

The buried tube 101 has 12 flow paths Fp1, Fp2, . . . , and Fp12 having a U shape in plan view, and the 12 flow paths Fp1, Fp2, . . . , and Fp12 are individually disposed under the 12 divided areas. The inlet sides of the 12 flow paths Fpi (i=1 to 12) are coupled with a common collecting duct, and slide gate dampers 104, 104, . . . , and 104 for flow rate adjustment are disposed at the inlets of the 12 flow paths Fpi (i=1 to 12).
Then, an outlet thermometer 102, an outlet flowmeter 103, and a fan 105 are disposed, in this order, at the flow path on the outlet side of each of the 12 flow paths Fp1, Fp2, . . . , and Fp12.

Note that, instead of coupling the inlet sides of the flow paths Fp1 to Fp12 to the common collecting duct, the structure may be modified to directly take in outside air.

In addition, a single fan 105 may be shared by the plurality of flow paths Fp1 to Fp12 by coupling the outlets of the flow paths Fp1 to Fp12 downstream of the outlet flowmeters 103 to the common collecting duct.

### 1-8. About Heat Removal Amount Measurement Unit

Hereinbelow, a heat removal amount measurement unit of the air-cooling mechanism 100 is explained.

The air-cooling mechanism 100 of the present embodiment is provided with an unillustrated heat removal amount measurement unit.

The heat removal amount measurement unit measures the heat removal amount of the furnace bottom 1a for each of the divided areas on the basis of the output of the abovementioned outlet thermometer 102, the output of the outlet flowmeter 103, the air temperature on the side of the collecting duct (e.g. assumed to be ambient temperature), and known data such as the specific heat of air.

Then, an unillustrated control part of the air-cooling mechanism 100 monitors the heat removal amount for each of the divided areas measured by the heat removal amount measurement unit, and, in a case where there is a divided area where thermal load estimated from the heat removal amount exceeds a predetermined safety range, the control part increases the flow rate of the cooling air for the divided area by increasing the opening of the slide gate damper 104 corresponding to the divided area.

Accordingly, it is possible to avoid a situation where the thermal load of the furnace bottom 1a partially increases significantly; as a result, the integrity of the furnace bottom 1a is maintained.

On the other hand, the unillustrated control part of the air-cooling mechanism 100 monitors the heat removal amount for each of the divided areas measured by the heat removal amount measurement unit, and, in a case where there is a divided area where thermal load of the furnace bottom 1a estimated from the heat removal amount falls below the safety range, the control part reduces the flow rate of the cooling air for the divided area by reducing the opening of the slide gate damper 104 corresponding to the divided area. Accordingly, it is possible to avoid a situation where the furnace bottom 1a is partially overcooled; as a result, it is possible to prevent burial of the furnace bottom 1a (reduction of the furnace volume).

### 1-9. About Thermometer Unit

Hereinbelow, a thermometer unit of the air-cooling mechanism 100 is explained.

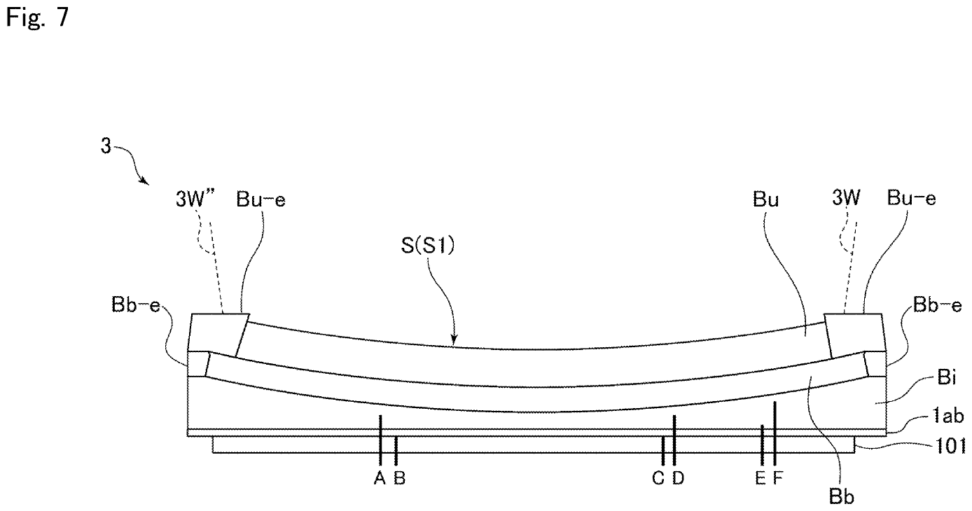

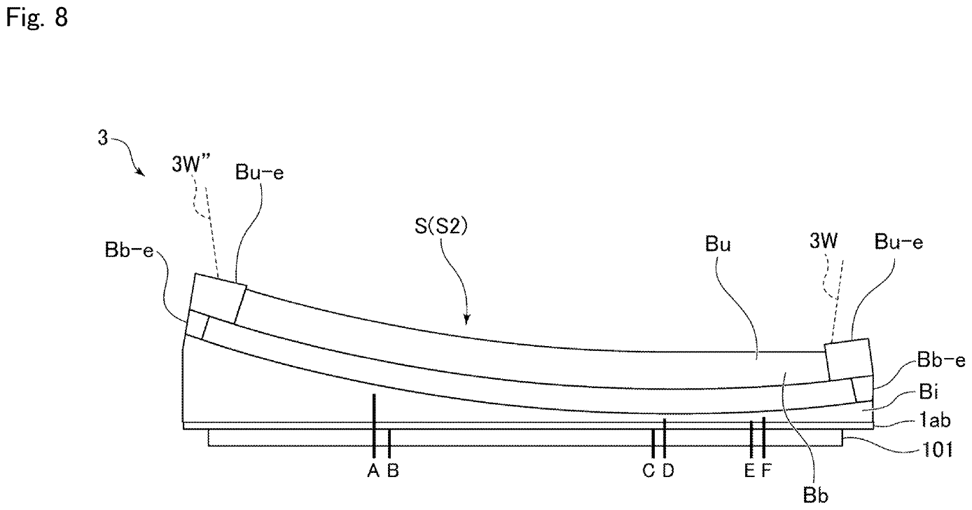

The air-cooling mechanism 100 of the present embodiment may be provided with the thermometer unit that measures the temperature of the furnace bottom 1a for each divided area. FIG. 7 is an explanatory diagram for explaining the layout of the thermometer unit in the cross-section taken along X-X in FIG. 1, and FIG. 8 is an explanatory diagram for explaining the layout of the thermometer unit in the cross-section taken along Y-Y in FIG. 1. The X-X cross section is a cross-section taken near the middle of the non-slope area S1 on the side of the uptake shaft 4, and the Y-Y cross section is a cross-section crossing the bottom part S2-b of the slope area S2.

As illustrated in FIG. 7 and FIG. 8, for example, six thermocouples A, B, C, D, E, and F as sensors of the thermometer unit are attached to the abovementioned 12 divided areas sequentially starting from the side of the back furnace wall 3W″.

The leading end part (sensing part) of each of the six thermocouples A, B, C, D, E, and F is inserted toward a deep part of the furnace bottom 1a from below the steel shell 1ab.

The positional relationship between the thermocouples B and C is set symmetrically with respect to a vertical plane to which the centerline extending in the long-side direction of the settler 3 belongs, the positional relationship between the thermocouples A and D is set symmetrically with respect to the vertical plane, and the thermocouple E and the thermocouple F are disposed next to each other at positions closer to the front furnace wall 3W. Among them, the horizontal positions of the thermocouples A and B are close to each other, the horizontal positions of the thermocouples C and D are close to each other, and the horizontal positions of the thermocouples E and F are close to each other.

Then, the vertical positions of the sensing parts of the thermocouples B and C are set equivalent to the vertical position of the steel shell 1ab, the vertical position of the sensing part (leading end) of the thermocouple E is set slightly higher than the vertical position of the upper end of the steel shell 1ab, and the vertical positions of the sensing parts of the thermocouples A, D and F are all set to the vertical positions of deep parts of the filling brick area Bi.

It should be noted that differences in height are provided between the sensing parts of the thermocouple A, D, and F so as to match the reverse arched shape of the lower furnace bottom brick area Bb.

Accordingly, the thermometer unit of the present embodiment is capable of measuring the temperature of the furnace bottom 1a for each of the 12 divided areas and is capable of specifically measuring, in particular, the temperature of a portion close to the front furnace wall 3W in each divided area.

For example, in the X-X cross section illustrated in FIG. 7, the vertical positions of the sensing parts of the thermocouples A to F are set as follows.

The following numerical values are the vertical positions of the sensing parts relative to the vertical position of the steel shell 1ab.
Thermocouples A and D: 160 mm
Thermocouples B and C: 0 mm
Thermocouple E: 100 mm
Thermocouple F: 225 mm

In addition, for example, in the Y-Y cross section illustrated in FIG. 8, the vertical positions of the sensing parts of the thermocouples A to F are set as follows. The following numerical values are the vertical positions of the sensing parts relative to the vertical position of the steel shell 1ab.
Thermocouple A: 300 mm
Thermocouples D and F: 20 mm
Thermocouples B and C: 0 mm
Thermocouple E: 100 mm

Note that whereas it is assumed here that the vertical positions of the sensing parts of the thermocouples are at deep parts of the filling brick area Bi, the vertical positions of the sensing parts of the thermocouples can be set to other positions such as the lower end of the upper furnace bottom brick area Bu, inner parts of the lower furnace bottom brick area Bb, or the lower end of the lower furnace bottom brick area Bb.

Then, the control part of the air-cooling mechanism 100 monitors the temperature for each of the divided areas measured by the thermometer unit, and, in a case where there is a divided area where thermal load of the furnace bottom 1a estimated from the temperature exceeds a predetermined safety range, the control part increases the flow rate of the cooling air for the divided area by increasing the opening of the slide gate damper 104 corresponding to the divided area. Accordingly, it is possible to avoid a situation where the thermal load of the furnace bottom 1a partially increases significantly; as a result, the integrity of the furnace bottom 1a is maintained.

On the other hand, the control part of the air-cooling mechanism 100 monitors the temperature for each of the divided areas measured by the thermometer unit, and, in a case where there is a divided area where thermal load of the furnace bottom 1a estimated from the temperature falls below the safety range, the control part reduces the flow rate of the cooling air for the divided area by reducing the opening of the slide gate damper 104 corresponding to the divided area. Accordingly, it is possible to avoid a situation where the furnace bottom 1a is partially overcooled; as a result, it is possible to prevent burial of the furnace bottom 1a (reduction of the furnace volume).

### 1-10. Slag Tapping

Hereinbelow, a process (slag tapping) of withdrawing a slag from the flash smelting furnace 1 of the abovementioned embodiment is explained.

It is assumed here that the operation of the flash smelting furnace 1 is performed continuously.

The manager of the flash smelting furnace 1 of the present embodiment almost continuously performs slag tapping to withdraw a slag through the slag tap holes Hb and pauses the tapping at a frequency of once every two to three hours.

For example, in a case where the slag production amount is approximately 2800 t/d, and the slag tapping time is 21 hours per day, the slag discharge rate is 130 t/h.
By almost continuously discharging a slag at an appropriate speed in this manner, it is possible to avoid a situation where the surface level of the slag layer 3b exceeds a molten material retention tolerated level of the inside of the furnace.

### 1-11. Matte Tapping

Hereinbelow, a process (matte tapping) of withdrawing matte from the flash smelting furnace 1 of the abovementioned embodiment is explained.

It is assumed also here that the operation of the flash smelting furnace 1 is performed continuously.

The manager of the flash smelting furnace 1 of the present embodiment performs matte tapping to withdraw matte through the matte tap holes Ha at a frequency of once per hour, for example.

In a single matte tapping, simultaneous discharge from three matte tap holes Ha in the six matte tap holes Ha is performed over a period of approximately 30 minutes.
For example, in a case where the matte production amount is approximately 1700 t/d, and the matte tapping time is 24 times×30 minutes per day, the matte discharge rate is 140 t/h (47 t/h per matte tap hole). Assuming that the vertical position of a slag tap hole level Lb relative to the vertical position of the matte tap hole level La is, for example, 800 mm, the matte tapping of the present embodiment allows the matte bath depth to be equal to or smaller than 750 mm, for example. Accordingly, it is possible to prevent matte from being discharged from the slag tap holes Hb due to an increase of the surface level of the matte layer 3a and to prevent deterioration of the copper (Cu) recovery rate.

### 1-12. Metal Tapping

Hereinbelow, a process (metal tapping) of withdrawing molten metal from the flash smelting furnace 1 of the abovementioned embodiment is explained.

It is assumed also here that the operation of the flash smelting furnace 1 is performed continuously.

### 1-12-1. Start Control

The manager of the flash smelting furnace 1 of the present embodiment starts the process of withdrawing molten metal through the metal tap holes Hc of the front furnace wall 3W in a case where the surface level of the molten metal has reached a matte tap hole level La.

For example, the manager of the flash smelting furnace 1 can determine whether or not the surface level of the molten metal has reached the matte tap hole level La on the basis of whether or not the molten metal has started being mixed in the matte withdrawn through the matte tap holes Ha of the front furnace wall 3W.

Alternatively, the manager of the flash smelting furnace 1 inserts an inspection level gauging rod (rod) from an inspection level gauging hole provided through the ceiling of the settler 3 toward the furnace bottom surface S, causes the leading end of the inspection level gauging rod to be abutted on the furnace bottom surface S, and can determine whether or not the surface level of the molten metal has reached the matte tap hole level La on the basis of whether or not the adhesion range of the molten metal on the inspection level gauging rod has reached a level corresponding to the matte tap hole level La.

Note that whereas it is assumed here that the condition under which the process of withdrawing the molten metal through the metal tap holes Hc is started is that “in a case where the surface level of the molten metal has reached the matte tap hole level La,” the condition may be that “in a case where the surface level of the molten metal is predicted to have reached the matte tap hole level La.”

For example, such a prediction can be performed on the basis of the composition of the raw material that is actually charged into the flash smelting furnace 1 and the processing amount of the flash smelting furnace 1.

### 1-12-2. Stop Control

The manager of the flash smelting furnace 1 of the present embodiment stops the process of withdrawing the molten metal through the metal tap holes Hc in a case where the surface level of the molten metal has lowered to a second level lower than the matte tap hole level La.

For example, the manager of the flash smelting furnace 1 inserts the inspection level gauging rod from the inspection level gauging hole provided through the ceiling of the settler 3 toward the furnace bottom surface S and can determine whether or not the surface level of the molten metal has lowered to the second level lower than the matte tap hole level La on the basis of whether or not the adhesion range of the molten metal on the inspection level gauging rod has lowered to a level corresponding to the second level.

It should be noted that the manager of the flash smelting furnace 1 stops the process (matte tapping) of withdrawing the matte through the matte tap holes Ha of the front furnace wall 3W in a case where the process of withdrawing the molten metal through the metal tap holes Hc of the front furnace wall 3W is started and stops the process (metal tapping) of withdrawing the molten metal through the metal tap holes Hc of the front furnace wall 3W in a case where the process of withdrawing the matte through the matte tap holes Ha of the front furnace wall 3W is started.

Note that whereas it is assumed here that the condition under which the process of withdrawing the molten metal through the metal tap holes Hc is stopped is that “in a case where the surface level of the molten metal has lowered to the second level lower than the matte tap hole level La,” the condition may be that “in a case where the surface level of the molten metal is predicted to have lowered to the second level lower than the matte tap hole levels La.”

For example, such a prediction can be performed on the basis of the composition of the raw material that is actually charged into the flash smelting furnace 1 and the processing amount of the flash smelting furnace 1.

### 1-13. Other Tapping

Other than these, for example, the manager of the flash smelting furnace 1 of the present embodiment may perform a process of withdrawing all molten materials including the molten metal, the matte, and the slag through the metal tap holes Hc as necessary before the operation of the flash smelting furnace is to be stopped for a long term, before a furnace bottom refractory material is to be replaced, and so on.

By withdrawing the molten material through the metal tap holes Hc provided at positions lower than the matte tap holes Ha, residual molten material inside the furnace can be eliminated surely. Accordingly, it is possible to reduce the melting time of solidified matters inside the furnace at the time when the operation of the flash smelting furnace 1 is to be resumed, to reduce the labor for engineering work of dismantling solidified matters of residual molten material inside the furnace before a furnace bottom refractory material is to be replaced, and so on.

### 1-14 Advantageous Effects of Embodiment

As explained above, since the flash smelting furnace 1 according to the present embodiment includes: the slope area S2 that guides molten metal remaining at a lower part of the matte layer 3a without being sulfided to the side of the front furnace wall 3W; and the metal tap holes Hc through which molten metal accumulated at the bottom part S2-b of the slope area S2 is withdrawn to the outside of the furnace, the molten metal can be withdrawn timely and smoothly.

Therefore, it is possible to reduce: (1) the risk that molten metal accumulated at the middle of the furnace bottom surface S of the flash smelting furnace 1 leaks from the furnace bottom 1a; (2) the risk that molten metal that has reached the matte tap hole level La damages the matte gutter made of copper; (3) the risk that high impurity metal is unintentionally and undesirably supplied to the converter; and (4) the risk that the water-cooling elements made of copper included in the furnace wall of the flash smelting furnace 1 is damaged.

Accordingly, the flash smelting furnace 1 and the operation method thereof according to the present embodiment achieve the advantageous effect that the operation can be continued safely even in a case where the charging proportion of a metal-based recycled raw material has increased.

In addition, since the flash smelting furnace 1 of the present embodiment includes the air-cooling mechanism 100, even if molten metal is accumulated at the bottom part S2-b of the slope area S2 for a certain length of time, it is possible to reduce the risk that the molten metal penetrates into the joints of the furnace bottom bricks and the risk that the molten metal infiltrates into the furnace bottom bricks by forming an appropriate temperature distribution in the height direction of the furnace bottom 1a. Therefore, it is possible to cause the molten metal to stably remain inside the flash smelting furnace 1.

Note that, although the remnant amount of molten metal and the increase rate of the remnant amount differ depending on the composition of the raw material charged into the flash smelting furnace 1 and the degree of operation, for example, by grasping or estimating the amount of remaining molten metal at a frequency of once every two hours, and discharging molten metal at the time point when the remnant amount has reached a certain amount, it is possible to keep the time during which molten metal remains at the bottom part S2-b of the slope area S2 within a safety range.

For example, in a case where the increase rate of the amount of molten metal remaining at the bottom part S2-b is 2 t/h, the molten metal is discharged either at intervals corresponding to the time required for the remnant amount to reach approximately 24 t, which is an amount corresponding to half a day (=every 12 hours), or in a case where the measured depth of molten metal has reached 100 mm, and thereby it is possible to discharge the molten metal to the outside of the furnace before the melting point lowers.

As a result, it is possible to reduce the risk that the molten metal penetrates into the joints of the furnace bottom bricks and the risk that the molten metal infiltrates into the furnace bottom bricks.

In addition, since the air-cooling mechanism 100 of the present embodiment adjusts the air-cooling intensity for each of the divided areas at the furnace bottom 1a, it is possible to intensively cool some divided areas (below the slope area S2) where the molten metal is remaining.

Therefore, it is possible to keep the thermal load of each of the 12 divided areas of the furnace bottom 1a within a safety range and to pursue both maintenance of the integrity of the furnace bottom 1a and prevention of a volumetric decrease due to overcooling.

In addition, the flash smelting furnace 1 of the present embodiment can be easily obtained simply by partially changing the arch rise structure and the skew brick structure of the furnace bottom of a conventional flash smelting furnace.

In addition, since the flash smelting furnace 1 of the present embodiment enables tapping of molten metal in the horizontal direction from the metal tap holes Hc, the flash smelting furnace 1 is highly safe as compared with a case where molten metal is tapped from the bottom.

In addition, the flash smelting furnace 1 of the present embodiment can be operated similarly to a conventional flash smelting furnace in a case where the charging proportion of a metal-based recycled raw material is low.

### 2. Modification Example of Flash Smelting Furnace and Operation Method Thereof

### 2-1. Measures Against Accretion

If the operation of the flash smelting furnace 1 is continued in the abovementioned embodiment, there is also a possibility that magnetite-based accretion is formed at the bottom part of the slope area S2, and the volume available for accumulation of molten metal at the bottom part (concave part) of the slope area S2 decreases.

In such a case, magnetite may be reduced, and the volume of the bottom part (concave part) of the slope area S2 may be recovered by operating the flash smelting furnace 1 under conditions in which molten metal is not produced (e.g. conditions in which a copper-metal-based recycled raw material is not charged) to cause matte to remain at the bottom part of the slope area S2 and charging a reducing agent such as iron granules (Fe granules) into the inside of the furnace.

### 2-2. About Metal Tap Holes

Whereas the number of the metal tap holes Hc is two in the embodiment or the modification example, the number of the metal tap holes Hc may be any number other than two.

### 2-3. About Divided Areas

Whereas the number of the divided areas of the furnace bottom 1a is 12 in the embodiment or the modification example, the number of the divided areas of the furnace bottom 1a may be any number other than 12.

### 2-4. About Air-Cooling Mechanism

Whereas the control part of the air-cooling mechanism 100 performs the temperature control of the furnace bottom 1a for each of the divided areas on the basis of either of the heat removal amount measured by the heat removal amount measurement unit or the temperature measured by the thermometer unit in the embodiment or the modification example, the control part may perform the temperature control on the basis of both of them.

For example, the control part of the air-cooling mechanism 100 may enhance the accuracy of the heat removal amount measured by the heat removal amount measurement unit on the basis of the temperature measured by the thermometer unit and perform the temperature control for each of the divided areas on the basis of the highly accurate heat removal amount.

For example, the control part of the air-cooling mechanism 100 may determine whether it is necessary or not necessary to open or close the slide gate damper 104 corresponding to a certain divided area on the basis of the measured heat removal amount of the divided area and decide the opening of the slide gate damper 104 corresponding to the divided area on the basis of the measured temperature of the divided area.

### 2-5 Operating Conditions of Flash Smelting Furnace

Note that, in the abovementioned embodiment or modification example of the flash smelting furnace operation method, the operating conditions of the flash smelting furnace 1 may be set such that the oxygen partial pressure (atm) inside the flash smelting furnace 1 during operation falls within range of 10⁻¹⁰ to 10⁻⁶.

For example, in a case where the oxygen partial pressure (atm) inside the furnace of the reaction shaft 2 becomes approximately 10⁻⁸, and free air has entered the inside of the furnace or in other cases, the operating conditions of the flash smelting furnace 1 are set such that the oxygen partial pressure (atm) of the inside of the furnace of the settler 3 becomes approximately 10⁻⁷.

In addition, in the abovementioned embodiment or modification example of the flash smelting furnace operation method, the operating conditions of the flash smelting furnace 1 may be set such that the copper grade (weight %) of matte (flash smelting furnace matte) withdrawn from the flash smelting furnace 1 falls within the range of 50% to 70%. For example, in order to make the copper grade (weight %) of flash smelting furnace matte withdrawn from the flash smelting furnace 1 65%, the operating conditions of the flash smelting furnace 1 are set such that the copper grade (weight %) of matte produced inside the furnace of the reaction shaft 2 is slightly lower (e.g. 59%) than the target value (here, 65%).

In addition, in the abovementioned embodiment or modification example of the flash smelting furnace operation method, the operating conditions of the flash smelting furnace 1 may be set such that the copper grade (weight %) in molten metal inside the flash smelting furnace 1 falls within the range of 50% to 100%, and the concentration of impurities (iron, tin, lead) in the molten metal falls within the range of 0% to 50%. For example, the operating conditions of the flash smelting furnace 1 are set such that the copper grade (weight %) in molten metal falls within the range of 70% to 90%.

In addition, operating conditions that can be adjusted in order to cause the copper grade of flash smelting furnace matte withdrawn through the matte tap holes Ha of the flash smelting furnace 1 to fall within an appropriate range and to cause the copper grade of molten metal withdrawn through the metal tap holes Hc of the flash smelting furnace 1 to fall within an appropriate range are the composition of the raw material supplied to the flash smelting furnace 1, for example. Since the raw material supplied to the abovementioned flash smelting furnace 1 includes at least a metal-based recycled raw material (hereinbelow, referred to as a “recycled raw material” simply) and copper concentrate, the composition of the raw material can be adjusted by adjusting the weight ratio of the recycled raw material, the type of the recycled raw material, the combination of types of the recycled raw material, the weight ratio of each type of recycled raw material, and the like.

In addition, in a case where the weight ratio of the recycled raw material supplied to the flash smelting furnace 1 is high, and the molten material temperature of the inside of the flash smelting furnace 1 lowers due to an insufficient reaction heat amount or in other cases, the molten material temperature of the inside of the furnace may be increased by thermal compensation using fossil fuels, hydrogen, electrodes, or a combination of these. In addition, the thermal balance of the inside of the furnace may be adjusted by increasing the oxygen concentration of a reaction gas blown toward the flash smelting furnace 1, lowering the supply rate of a non-exothermic substance supplied to the flash smelting furnace 1, and so on.

In addition, the recycled raw material supplied to the flash smelting furnace 1 may include at least one of (1) to (5) described below.
(1) Smaller particulate raw material that has been incinerated and finely pulverized and has particle sizes ranging from several micrometers to several hundred micrometers
(2) Smaller particulate raw material that has been finely pulverized without being incinerated and has particle sizes ranging from approximately several micrometers to approximately several hundred micrometers
(3) Particulate raw material that has not been pulverized at a fine pulverization process and has particle sizes ranging from several millimeters to several tens of millimeters
(4) Particulate raw material that has not undergone a fine pulverization process and has particle sizes ranging from several millimeters to several tens of millimeters
(5) Smaller particulate raw material that has not undergone a fine pulverization process and has particle sizes ranging from several micrometers to several hundred micrometers

Note that, in the present specification, a raw material having micrometer sizes is referred to as a “smaller particulate raw material” and a raw material having millimeter sizes is referred to as a “particulate raw material.”

In addition, in the operation of the flash smelting furnace 1, pretreatment conditions (e.g. the degree and presence/absence of a fine pulverization process) of a recycled raw material may be adjusted in accordance with the content amount of impurities in the recycled raw material. By appropriately performing this adjustment, oxidation of impurities (tin, lead, chromium, etc.) in the recycled raw material can be promoted at each of the step of passage of the slag layer of the flash smelting furnace 1 and the step of passage of an intermediate layer at the boundary between the slag layer and the matte layer. Accordingly, it becomes easier for the impurities (tin, lead, chromium, etc.) to be taken into the flash smelting furnace slag. As a result, it becomes possible to efficiently cut the impurities out of the system in the flash smelting furnace 1.

### 3. About Copper Smelting Method

Hereinbelow, an embodiment of a copper smelting method using the abovementioned embodiment or modification example of the flash smelting furnace operation method is explained.

The copper smelting method of the present embodiment makes it possible to stably process a recycled raw material containing an amount of metal components exceeding the capability of the flash smelting furnace 1 to convert the metal components into matte.

### 3-1. Conventional Copper Smelting Method

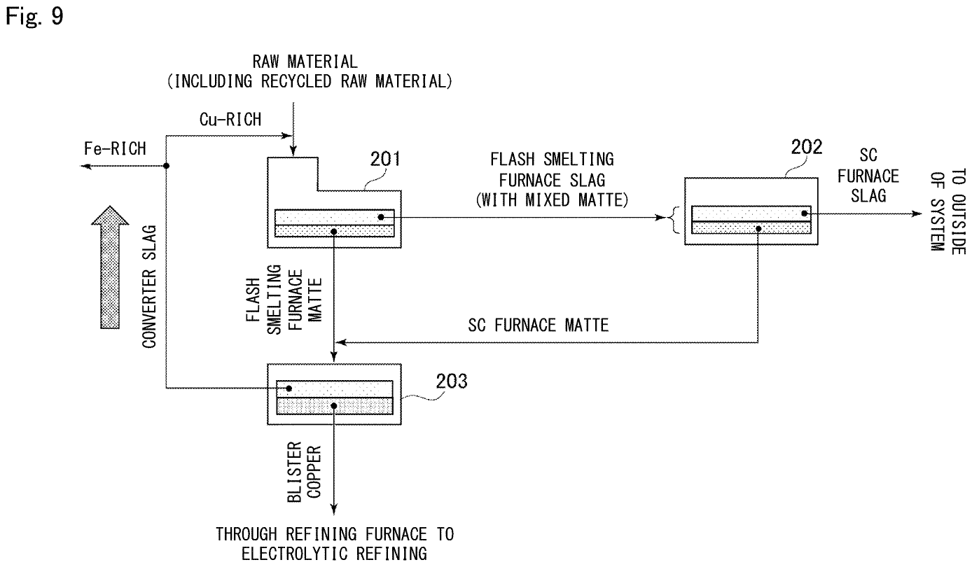

First, for comparison, a conventional copper smelting method is explained. FIG. 9 is a schematic diagram for explaining the procedure of the conventional copper smelting method. As illustrated in FIG. 9, a conventional flash smelting furnace 201, converter 203, SC furnace 202, and the like are used for the conventional copper smelting method.

For example, the raw material supplied to the flash smelting furnace 201 is a combination of copper concentrate and a recycled raw material, and the weight ratio of the recycled raw material in the entire raw material supplied to the flash smelting furnace 201 is approximately 8 to 10 wt %.

The converter 203 is the first post-process furnace that processes flash smelting furnace matte which is matte withdrawn through matte tap holes of the conventional flash smelting furnace 201.

The SC furnace 202 is the second post-process furnace that processes a flash smelting furnace slag which is a slag withdrawn through slag tap holes of the conventional flash smelting furnace 201.

Meanwhile, the SC furnace 202 is called a “slag cleaning furnace” in some cases.

Inside the SC furnace 202, the flash smelting furnace slag supplied to the SC furnace 202 is separated into SC furnace matte (an example of the second matte) which is matte containing copper and an SC furnace slag (an example of the second slag) present on the SC furnace matte. The separated SC furnace slag is discharged to the outside of the system, and the SC furnace matte is supplied to the converter 203.

The flash smelting furnace matte and the SC furnace matte supplied to the converter 203 are oxidized within the converter 203 to be separated into blister copper from which impurities have been removed and a converter slag containing impurities. The blister copper from which impurities have been removed is processed to have an increased purity in an unillustrated refining furnace and then transferred further to a post-process electrolytic refining process, and electrolytic copper which is a copper product (pure copper as product) is produced.

In such a conventional copper smelting method, the processing amount of the recycled raw material in the flash smelting furnace 201 is limited, and accordingly a process illustrated by a route (hereinbelow, a “return route”) indicated by a black thick arrow in FIG. 9 is performed. In this return route, for example, part of the recycled raw material that should be processed at a copper smelting process is supplied to the converter 203, a converter slag generated in the converter 203 is solidified/crushed and then is separated into a Fe-rich alloy phase and a Cu-rich alloy phase by a flotation process, and the Cu-rich alloy phase is returned to the flash smelting furnace 201 while the Fe-rich alloy phase is discharged to the outside of the system. Note that, in this return route, the converter slag generated in the converter 203 can also be returned to the flash smelting furnace 201 as molten material (without undergoing solidification/crushing/flotation steps).

Meanwhile, the converter slag processed in such a return route is called a “return slag” or the like.

### 3-2. Embodiment of Copper Smelting Method

Next, an embodiment of the copper smelting method is explained.

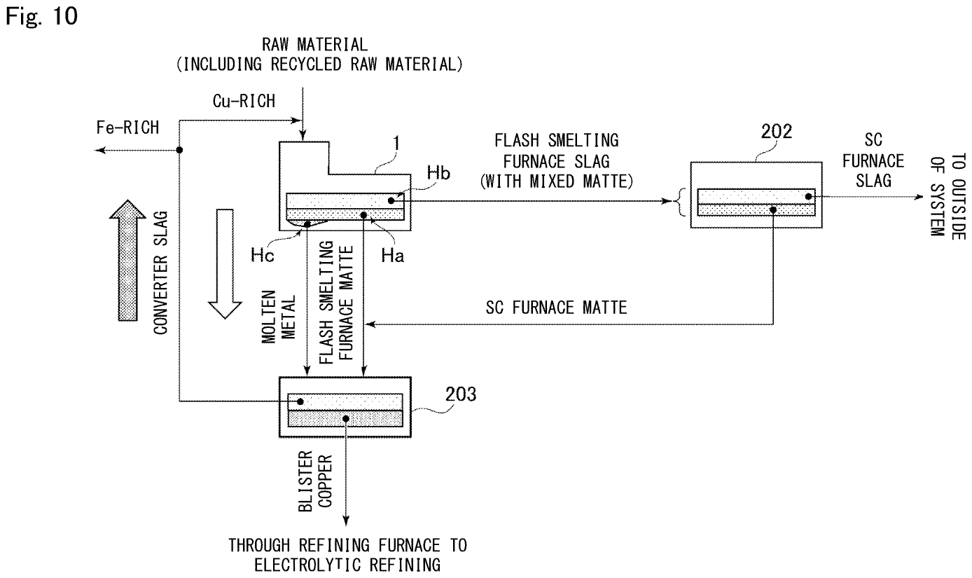

FIG. 10 is a schematic diagram for explaining the procedure of an embodiment of the copper smelting method. Here, differences from the conventional smelting method illustrated in FIG. 9 are mainly explained, and the explanation of common points is omitted.

In the copper smelting method of the present embodiment, as illustrated in FIG. 10, the flash smelting furnace 1 according to the abovementioned embodiment or modification example is used. The raw material supplied to the flash smelting furnace 1 also is a combination of copper concentrate and a recycled raw material.

It should be noted that it is assumed in the copper smelting method of the present embodiment that the weight ratio of the recycled raw material in the entire raw material supplied to the flash smelting furnace 1 is, for example, 10 to 35 wt %, and the weight ratio of a particle raw material to a smaller particulate raw material in the recycled raw material is greater than “1” (the amount of the particulate raw material is greater than the amount of the smaller particulate raw material). In a case where the weight ratio is set in such a ratio, molten metal derived from the recycled raw material is likely to settle inside the flash smelting furnace 1, and accordingly a greater amount of the molten metal can be recovered through the metal tap holes Hc.

Then, the molten metal withdrawn through the metal tap holes Hc of the flash smelting furnace 1 is supplied to the converter 203 as the first post-process furnace together with flash smelting furnace matte withdrawn through the matte tap holes Ha of the flash smelting furnace 1. Therefore, copper contained in the molten metal is recovered as blister copper in the converter 203 together with copper contained in the flash smelting furnace matte (see a recovery route indicated by a white thick arrow in FIG. 10). Note that converter slag produced in the converter 203 is processed in a return route similar to that in the conventional method (a black thick arrow in FIG. 10). Accordingly, the copper smelting method of the present embodiment makes it possible to increase the amount of the recycled raw material to be supplied to the flash smelting furnace 1 while ensuring safety of the flash smelting furnace 1 since the route (the white thick arrow in FIG. 10) through which the molten metal in the flash smelting furnace 1 is transferred to the converter 203 is used.

In addition, the copper smelting method of the present embodiment reduces the amount of impurities that are mixed on the side of the flash smelting furnace matte and, as a result, reduces the amount of impurities in the blister copper produced in the converter 203 and the amount of impurities in the converter slag since it is possible to efficiently transfer impurities in the flash smelting furnace 1 to the side of the flash smelting furnace slag.

On the other hand, the flash smelting furnace slag withdrawn through the slag tap holes Hb of the flash smelting furnace 1 is supplied to the SC furnace 202.

The flash smelting furnace slag supplied to the SC furnace 202 is separated into SC furnace matte (an example of the second matte) containing copper and an SC furnace slag (an example of the second slag) present on the SC furnace matte.
The separated SC furnace slag is discharged to the outside of the system, and the separated SC furnace matte is supplied to the converter 203.

Note that, in a case where the amount of the recycled raw material supplied to the flash smelting furnace 1 is great, the concentration of impurities such as Al and Cr in the flash smelting furnace slag increases, and there is a possibility that the fluidity of the flash smelting furnace slag worsens, and the operability worsens.

In view of this, in the copper smelting method of the present embodiment, when separating the flash smelting furnace slag into the SC furnace matte and the SC furnace slag by the SC furnace 202 (or the slag cleaning furnace),
at least one of:
(1) a process of reducing the SC furnace slag;
(2) a process of increasing the temperature of the SC furnace slag; or
(3) a process of supplying an additive for modifying the SC furnace slag
may be executed. At least one of these processes can improve the fluidity of the SC furnace slag.

In addition, in the copper smelting method of the present embodiment, a ladle, a gutter, or a combination of these can be used to transfer the molten metal from the flash smelting furnace 1 to the converter 203. In addition, when the molten metal is transferred using a ladle, the storability and the transferability may be enhanced by solidifying the molten metal in the ladle before being supplied to the converter 203.

### 3-3. Second Embodiment of Copper Smelting Method

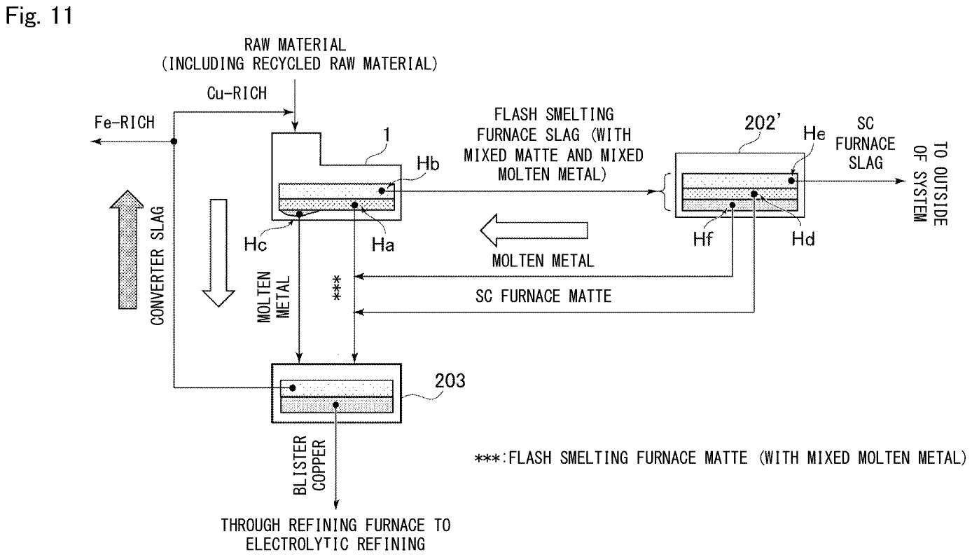

Next, a second embodiment of the abovementioned copper smelting method is explained. FIG. 11 is a schematic diagram for explaining the procedure of the second embodiment of the copper smelting method. Here, differences from the embodiment of the copper smelting method illustrated in FIG. 10 are mainly explained, and the explanation of common points is omitted.

Whereas the flash smelting furnace 1 is used as illustrated in FIG. 11 in the copper smelting method of the second embodiment also, the copper smelting method of the second embodiment is different from the copper smelting method of the first embodiment in that an SC furnace 202′ is used instead of the SC furnace 202.

In the copper smelting method of the second embodiment also, the raw material supplied to the flash smelting furnace 1 is a combination of copper concentrate and a recycled raw material, and the weight ratio of the recycled raw material in the entire raw material supplied to the flash smelting furnace 1 is 10 to 35 wt %, for example.

It should be noted that it is assumed in the copper smelting method of the second embodiment that the weight ratio of a particulate raw material to a smaller particulate raw material in the recycled raw material supplied to the flash smelting furnace 1 is smaller than “1” (the amount of the particulate raw material is smaller than the amount of the smaller particulate raw material).

In a case where the weight ratio is set to such a ratio, molten metal is unlikely to settle inside the flash smelting furnace 1, and accordingly it is considered that the molten metal having been unable to reach the molten metal layer (the reference sign 3c in FIG. 1) inside the flash smelting furnace 1 is mixed in flash smelting furnace matte and a flash smelting furnace slag.

However, in the copper smelting method of the second embodiment, the molten metal is allowed to be mixed in the flash smelting furnace matte.

This is because the flash smelting furnace matte in which the molten metal is mixed is supplied to the converter 203, and accordingly this allows for recovery of copper contained in the molten metal (see a recovery route indicated by a white thick arrow on the left side in FIG. 11).

In addition, in the copper smelting method of the second embodiment, the molten metal is also allowed to be mixed in the flash smelting furnace slag.

However, in addition to this, in the copper smelting method of the present embodiment, after the flash smelting furnace slag in which the molten metal is mixed is supplied to the SC furnace 202′, a sufficient length of time is ensured when the flash smelting furnace slag is separated into the SC furnace slag and the SC furnace matte present therebelow, to thereby cause the molten metal mixed in the flash smelting furnace slag to settle on the furnace bottom surface of the SC furnace 202′.
Then, the molten metal having settled is supplied to the converter 203 together with the SC furnace matte to thereby allow for recovery of copper contained in the molten metal (see a recovery route indicated by a white thick arrow on the right side in FIG. 11).

Note that the SC furnace 202′ of the second embodiment may be provided with metal tap holes Hf for withdrawing the molten metal, in addition to matte tap holes Hd for withdrawing the SC furnace matte and slag tap holes He for withdrawing the SC furnace slag. This is because the thus-configured SC furnace 202′ enables efficient withdrawal of the molten metal having settled on the furnace bottom surface of the SC furnace 202′ and the SC furnace matte present thereon individually.

Note that, in the copper smelting method of the second embodiment, the weight ratios of the smaller particulate raw material and the particulate raw material in the recycled raw material supplied to the flash smelting furnace 1 may be adjusted in order to adjust the balance between the amount of the molten metal withdrawn from the SC furnace 202′ and the amount of the molten metal withdrawn from the flash smelting furnace 1. For example, the weight ratio of the smaller particulate raw material in the recycled raw material supplied to the flash smelting furnace 1 may be increased in order to increase the amount of the molten metal withdrawn from the SC furnace 202′, or the weight ratio of the smaller particulate raw material in the recycled raw material supplied to the flash smelting furnace 1 may be reduced in order to increase the amount of the molten metal withdrawn from the flash smelting furnace 1. Methods that can be adopted to adjust the weight ratio of the smaller particulate raw material in the recycled raw material include a method in which pretreatment conditions (e.g. the degree and presence/absence of a fine pulverization process) of the recycled raw material is adjusted and the like.

In addition, whereas the SC furnace 202′ provided with the metal tap holes Hf is used in the copper smelting method of the second embodiment, the SC furnace 202 similar to the one illustrated in FIG. 10 may be used as long as the molten metal and the SC furnace matte having settled can be appropriately withdrawn.

Note that, in a case where the amount of the recycled raw material supplied to the flash smelting furnace 1 is great, the concentration of impurities such as Al and Cr in the flash smelting furnace slag increases, and there is a possibility that the fluidity of the flash smelting furnace slag worsens, and the operability worsens; in addition, there is a possibility that the settlability of metal components suspended in the flash smelting furnace slag worsens. In view of this, in the copper smelting method of the second embodiment also, similarly to the copper smelting method of the abovementioned embodiment, when separating the flash smelting furnace slag into the SC furnace matte and the SC furnace slag by the SC furnace 202 (or the slag cleaning furnace),
at least one of:
(1) a process of reducing the SC furnace slag;
(2) a process of performing an operation to increase the temperature of the SC furnace slag; or
(3) a process of supplying an additive for modifying the SC furnace slag
may be executed. At least one of these processes can improve the fluidity of the SC furnace slag, and can reduce the suspension loss (recovery loss due to floating) of the SC furnace slag (loss of matte or metal without being recovered, remaining in a suspended state in the SC furnace slag).

### 3-3-1. First Modification Example of Second Embodiment of Copper Smelting Method

Hereinbelow, a first modification example of the second embodiment is explained.

Here, differences from the second embodiment are mainly explained, and the explanation of common points is omitted.

The copper smelting method according to the first modification example includes a process of separating the flash smelting furnace slag into the SC furnace matte and the SC furnace slag by the SC furnace.

When the separation is performed, at least one of:
(1) a process of reducing the SC furnace slag;
(2) a process of increasing the temperature of the SC furnace slag;
(3) a process of supplying an additive for modifying the SC furnace slag;
(4) a process of oxidizing the SC furnace slag;
(5) a process of oxidizing the SC furnace matte; or
(6) a process of increasing the temperature of the SC furnace matte
is executed.
   As a result, at least one advantageous effect of:
sedimentation separation of the matte suspended in the SC furnace slag;
removal of impurities in the SC furnace slag from the slag; or
transfer of components other than copper in the SC furnace matte to the SC furnace slag
can be achieved.

### 3-3-2. Second Modification Example of Second Embodiment of Copper Smelting Method

Hereinbelow, a second modification example of the second embodiment is explained.

Here, differences from the first modification example are mainly explained, and the explanation of common points is omitted.

The copper smelting method according to the second modification example includes a process of separating the flash smelting furnace slag into the SC furnace slag and the molten metal by the SC furnace.

When the separation is performed, at least one of:
(1) a process of reducing the SC furnace slag;
(2) a process of increasing the temperature of the SC furnace slag;
(3) a process of supplying an additive for modifying the SC furnace slag;
(4) a process of oxidizing the SC furnace slag; or
(7) a process of oxidizing the molten metal
is executed.
   As a result, at least one advantageous effect of:
sedimentation separation of the molten metal suspended in the SC furnace slag;
transfer of impurities in the SC furnace slag to the metal;
removal of impurities in the SC furnace slag from the slag; or
transfer of components other than copper in the molten metal into the SC furnace slag
can be achieved.

### 3-3-3. Third Modification Example of Second Embodiment of Copper Smelting Method

Hereinbelow, a third modification example of the second embodiment is explained.

Here, differences from the first modification example or the second modification example are mainly explained, and the explanation of common points is omitted. The third modification example combines the second modification example with the first modification example and includes a process of separating the flash smelting furnace slag into the SC furnace matte, the SC furnace slag, and the molten metal by the SC furnace.
When the separation is performed, at least one of:
(1) a process of reducing the SC furnace slag;
(2) a process of increasing the temperature of the SC furnace slag;
(3) a process of supplying an additive for modifying the SC furnace slag;
(4) a process of oxidizing the SC furnace slag;
(5) a process of oxidizing the SC furnace matte;
(6) a process of increasing the temperature of the SC furnace matte; or
(7) a process of oxidizing the molten metal
is executed. As a result, the state of distribution, to each phase, of components contained in the SC furnace matte, the SC furnace slag, and the molten metal can be controlled. Specifically, at least one advantageous effect of:
sedimentation separation of the SC furnace matte and the molten metal suspended in the SC furnace slag;
transfer of impurities in the SC furnace slag to the SC furnace matte and the SC furnace metal;
removal of impurities in the SC furnace slag from the slag;
transfer of impurities in the SC furnace slag to a gas phase sharing an interface with the slag; or
transfer of components other than copper in the SC furnace matte and the molten metal into the SC furnace slag
can be achieved.

### 3-4. Supplementary Notes on Copper Smelting Method

It is assumed that, in the abovementioned embodiment or modification examples of the copper smelting method, (1) to (6) described below are appropriately controlled in accordance with the operation cycle of the converter 203.
(1) The timings when the flash smelting furnace matte, the flash smelting furnace slag, and the molten metal are withdrawn from the flash smelting furnace 1;
(2) The amounts of the flash smelting furnace matte, the flash smelting furnace slag, and the molten metal to be withdrawn from the flash smelting furnace 1;
(3) The timing when the SC furnace matte is withdrawn from the SC furnace 202;
(4) The amount of the SC furnace matte to be withdrawn from the SC furnace 202;
(5) The timings when the SC furnace matte and the molten metal are withdrawn from the SC furnace 202′; and
(6) The amounts of the SC furnace matte and the molten metal to be withdrawn from the SC furnace 202′

### 4. Others

The present invention is not limited to each embodiment, and can be embodied by modifying constituent elements within the scope not departing from the gist. In addition, various inventions can be formed by combining a plurality of constituent elements disclosed in each embodiment as appropriate.

For example, some constituent elements may be deleted from all the constituent elements illustrated in the embodiments. Furthermore, constituent elements of different embodiments may be combined as appropriate. Although embodiments related to the flash smelting furnace as a copper smelting furnace and the operation method thereof are explained, the present invention can be applied also to smelting of a metal other than copper.

There is a possibility that one embodiment according to the present invention contributes to Goal 9, “build resilient infrastructure, promote inclusive and sustainable industrialization and foster innovation,” of Sustainable Development Goals (SDGs) led by the United Nations through its contribution to technological innovation in copper smelting.

In addition, there is a possibility that one embodiment according to the present invention contributes to Goal 12, “ensuring sustainable consumption and production patterns,” of Sustainable Development Goals (SDGs) led by the United Nations through promotion of the use of recycled raw materials.

### REFERENCE SIGNS LIST

1: flash smelting furnace
10: water-cooling element
101: buried tube
102: outlet thermometer
103: outlet flowmeter
104: slide gate damper
105: fan
1a: furnace bottom
1a: furnace bottom
1ab: steel shell
2: reaction shaft
3: settler
3W: front furnace wall
3W′: side furnace wall
3W″: back furnace wall
Ha: matte tap hole
3a: matte layer
3b: slag layer
3c: molten metal layer
4: uptake shaft
7: concentrate burner
8: oxygen-enriched air supplying part
Bb: lower area
Bb-e: skew brick part
Bi: filling brick area
Bu: upper area
Bu-e: skew brick part
Fp1 to Fp12: flow path
Hb: slag tap hole
Hc: metal tap hole
La: matte tap hole level
Lb: slag tap hole level
Lc: metal tap hole level
S: furnace bottom surface
S1: non-slope area
S1-u: top part
S1-b: bottom part
S2: slope area
S2-b: bottom part
201: flash smelting furnace (conventional flash smelting furnace)
202: SC furnace (example of second post-process furnace)
202′: SC furnace (example of second post-process furnace)
203: converter (example of first post-process furnace)
Hd: matte tap hole
He: slag tap hole
Hf: metal tap hole

1. A flash smelting furnace that separates a high temperature molten material produced by causing a raw material to react with oxygen in a reaction shaft into a matte layer containing matte which is a sulfide of a predetermined metal and a slag layer present on the matte layer on a furnace bottom surface of a settler, the flash smelting furnace comprising:
a predetermined slope area provided on the furnace bottom surface in order to guide molten metal which is a molten material of the predetermined metal having remaining at a lower part of the matte layer without being sulfided to a side of a furnace wall of the settler; and
a metal tap hole formed through the furnace wall in order to withdraw, to an outside of the furnace, the molten metal accumulated at a bottom part of the slope area.

2. The flash smelting furnace according to claim 1, wherein a formation range of the slope area is a predetermined range below the reaction shaft.

3. The flash smelting furnace according to claim 2, wherein
the furnace bottom surface of the settler is an upper end surface of a brick array incorporated into a round bottom shape, with a reverse arched shape in cross-section, and
a cross-sectional shape of the slope area of the furnace bottom surface is a reverse arched shape tilted such that a vertical position of a skew brick part on a side of the metal tap hole is lower than a vertical position of a skew brick part on a side opposite to the metal tap hole.

4. The flash smelting furnace according to claim 3, wherein a cross-sectional shape of a non-slope area of the furnace bottom surface has a reverse arched shape in which a vertical position of one skew brick part is the same as a vertical position of the other skew brick part.

5. The flash smelting furnace according to claim 3, wherein a vertical position of a bottom part of the slope area of the furnace bottom surface is lower than a vertical position of a bottom part of a non-slope area of the furnace bottom surface.

6. The flash smelting furnace according to claim 3, wherein
a vertical position of a matte tap hole of the furnace wall is set to the vertical position of the skew brick part of the non-slope area, and
a vertical position of the metal tap hole of the furnace wall is set to the vertical position of the skew brick part on the side of the metal tap hole of the slope area.

7. The flash smelting furnace according to claim 6, wherein a horizontal position of the metal tap hole of the furnace wall is adjusted not to be the same as a horizontal position of the matte tap hole of the furnace wall.

8. The flash smelting furnace according to claim 1, further comprising a gas-cooling mechanism that cools a furnace bottom of the settler for each of areas of the furnace bottom.

9. The flash smelting furnace according to claim 8, further comprising a heat removal amount measurement unit that measures an amount of heat removal by the gas-cooling mechanism for each of areas of the furnace bottom.

10. The flash smelting furnace according to claim 8, further comprising a thermometer unit that measures temperature of the furnace bottom of the settler for each of areas of the furnace bottom.

11. An operation method of the flash smelting furnace according to claim 1, the operation method comprising starting a process of withdrawing the molten metal through the metal tap hole of the furnace wall in a case where a surface level of the molten metal has reached a matte tap hole level or in a case where the surface level of the molten metal is predicted to have reached the matte tap hole level.

12. The operation method of the flash smelting furnace according to claim 11, the operation method further comprising stopping the process of withdrawing the molten metal through the metal tap hole in a case where the surface level of the molten metal has lowered to a second level lower than the matte tap hole level or in a case where the surface level of the molten metal is predicted to have reached the second level.

13. A metal smelting method using the flash smelting furnace according to claim 1, the metal smelting method comprising supplying molten metal withdrawn through the metal tap hole of the flash smelting furnace to a first post-process furnace together with flash smelting furnace matte withdrawn through the matte tap hole of the flash smelting furnace.

14. The metal smelting method according to claim 13, further comprising: separating a flash smelting furnace slag withdrawn through a slag tap hole of the flash smelting furnace into second matte containing the metal and a second slag present on the second matte by supplying the flash smelting furnace slag to a second post-process furnace; and supplying the second matte to the first post-process furnace.

15. The metal smelting method according to claim 14, further comprising, when separating the flash smelting furnace slag into the second matte and the second slag by the second post-process furnace, executing at least one of:
a process of reducing the second slag;
a process of increasing temperature of the second slag; or
a process of supplying an additive for modifying the second slag.

16. The metal smelting method according to claim 14, further comprising allowing molten metal to be mixed into the flash smelting furnace matte and supplying the flash smelting furnace matte in which the molten metal is mixed to the first post-process furnace.

17. The metal smelting method according to claim 14, further comprising:
allowing molten metal to be mixed into the flash smelting furnace slag and supplying the flash smelting furnace slag in which the molten metal is mixed to the second post-process furnace; and
causing the molten metal to settle on a furnace bottom surface of the second post-process furnace and supplying the molten metal having settled to the first post-process furnace together with the second matte.

18. The metal smelting method according to claim 17, further comprising, when the second post-process furnace is being operated, executing at least one of:
a process of reducing the second slag;
a process of increasing temperature of the second slag;
a process of supplying an additive for modifying the second slag;
a process of oxidizing the second slag;
a process of oxidizing the second matte;
a process of increasing temperature of the second matte; or
a process of oxidizing the molten metal.

19. The metal smelting method according to claim 17, wherein
the raw material includes a recycled raw material, and
the metal smelting method further comprises adjusting weight ratios of a smaller particulate raw material and a particulate raw material in the recycled raw material in order to adjust balance between an amount of molten metal withdrawn from the second post-process furnace and an amount of molten metal withdrawn from the flash smelting furnace.

20. The metal smelting method according to claim 19, further comprising adjusting a pretreatment condition of the recycled raw material in order to adjust the weight ratios.
